(19) United States
(12) Patent Application Publication
(10) Pub. No.: US 2012/0166286 A1
(43) Pub. Date: Jun. 28, 2012

(54) Method and Apparatus for Mobile Response Rate Tracking

(76) Inventors: Thomas Schuster, Oberursel (DE); Vinod Vasudevan, Trivandrum (IN)

(21) Appl. No.: 13/377,102

(22) PCT Filed: Sep. 15, 2009
(86) PCT No.: PCT/IB2009/054019

§ 371 Date: Mar. 19, 2012

(30) Foreign Application Priority Data
Jun. 10, 2009 (IN) 1362/CHE/2009

(51) Int. Cl. G06Q 30/02

(52) U.S. Cl. 705/14.64

(57) ABSTRACT

Techniques are described to compute response counts and response rates in a mobile marketing environment. Such techniques may be fully automated. Computed counts and rates are accessible in near real-time. Certain techniques use contextual information of transactions events to compute accurate response counts and rates. A flexible filtering algorithm may be configured and applied by a user.

### CROSS-REFERENCE TO RELATED APPLICATIONS

This application is a U.S. National Phase entry of International Application No. PCT/IB2009/054019, filed Sep. 15, 2009, which is incorporated herein by reference in its entirety, and additionally claims priority from Indian Patent Application No. 1362/CHE/2009, filed Jun. 10, 2009, which is also incorporated herein by reference in its entirety.

### FIELD OF THE INVENTION

The present invention relates to computing, intelligently and automatically, response counts and response rates for mobile marketing campaigns.

### BACKGROUND

Mobile is a type of media channel that has become more and more popular to use in a marketer's strategic mix of channels for marketing campaigns. More and more users of mobile phones no longer use the mobile phone exclusively for talking. For example, many mobile phone users use their mobile phones for obtaining information (e.g., news from news websites on the Internet) or for entertainment (e.g., games from game websites on the Internet.) Such users may be potential or niche target audiences for particular marketing campaigns from a marketer's point of view. For example, a marketer may send a campaign communication message (e.g., “Register by clicking this link and obtain a free ringtone of your choice”) to a mobile device (e.g., a mobile phone) over a mobile channel with the aim of getting the user to interact with the campaign, e.g., by responding to the campaign communication message in a particular way (e.g., the mobile phone user may purchase a product, thereby responding to a particular call to action of the campaign.)

### BRIEF DESCRIPTION OF DRAWINGS

The present invention is illustrated by way of example, and not by way of limitation, in the figures of the accompanying drawings and in which like reference numerals refer to similar elements and in which:

FIG. 1 is a schematic diagram showing a work flow for obtaining response counts and response rates, according to an embodiment;

FIG. 2A is a schematic diagram showing a work flow for intelligently and automatically computing response counts and response rates, according to an embodiment;

FIG. 2B is a detailed schematic diagram of the tracking system of FIG. 2A, according to an embodiment;

FIG. 3A-FIG. 3D is a flowchart of steps for intelligently and automatically computing response counts, according to an embodiment; and

FIG. 4 is a block diagram of a computer system on which embodiments may be implemented.

### DETAILED DESCRIPTION

### Definitions

Push Mobile Marketing Campaigns: Sending marketing communication initiated or triggered by the marketing person. This includes automated marketing communication scheduled by the marketer or triggered marketing initiated by a system. This includes any communication channel that is available on mobile phones. It should be appreciated that marketing campaigns may be triggered by an external system, such as, for example, a system including a trigger on a football goal won by a certain team and that, upon activation, results in a related product being sold to the recipients.

Pull Mobile Marketing Campaigns: Sending marketing communication in response to a consumer initiated communication. This may be a direct inbound communication, such as a text message, or a consumer interaction with any system (such as a commerce system, a customer service system, etc.) which triggers a communication response to the recipient.

Response: A response in mobile marketing as defined herein is an event of a recipient of a campaign, the event being responsive to a call to action of the campaign. Responses may be monetary transactions, such as purchases, but may also be any other desired event in response to a marketing stimulus (e.g., making a phone call, sending a text message, etc.) It should be appreciated that there may be multiple types of responses from recipients. Thus, referring to responses in this document herein includes any type of response.

Response Rate: Response rate is the ratio of the number of people who responded divided by the number of people who received a marketing stimulus (e.g., a marketing communication).

### Overview

Techniques are described to compute response counts and response rates in a mobile marketing environment. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring present embodiments.

### Manual Tracking of Mobile Marketing Campaigns

In an embodiment, a method for computing response counts and rates is to count the number of transaction events created after a mobile marketing campaign has been conducted. The response data is typically accessed manually or in a semi automated way. Data analysis tools, such as, for example, but not limited to, Microsoft Excel and Microsoft Access (both by Microsoft Corporation, Redmond, Wash.), may be used to manually compute response rates.

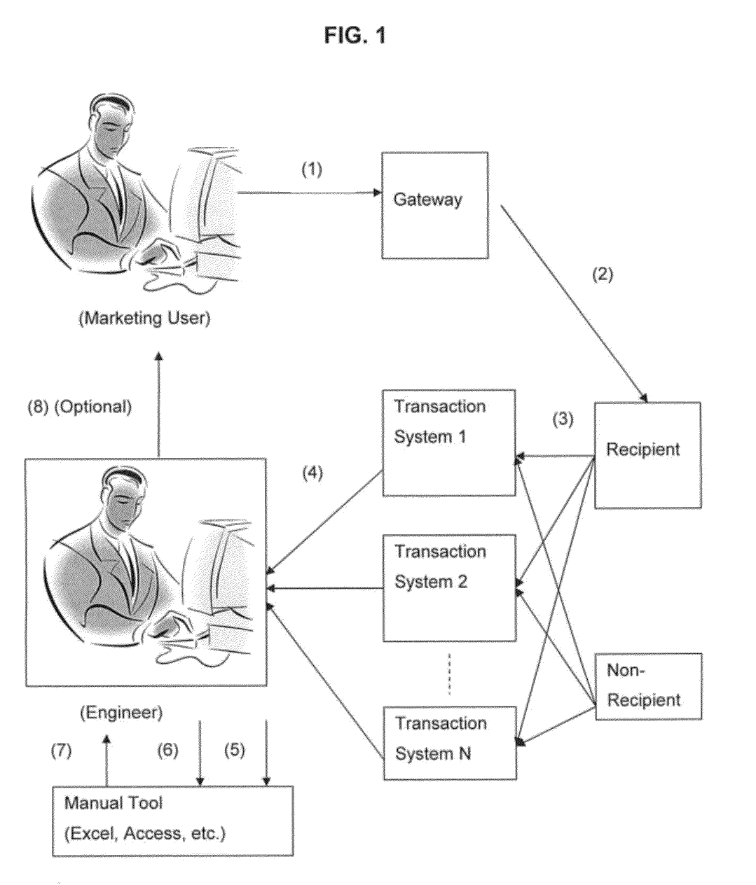

Referring to FIG. 1, an example embodiment showing tracking mobile marketing campaigns by manual data analysis of response data is described. In step 1, a marketing user submits a campaign for sending to a Gateway or similar technology for campaign delivery. In step 2, marketing communication reflecting the marketing campaign(s) gets sent to target recipients. In an embodiment, some of such target recipients respond to a call to action that is indicated in the marketing communication. For example, the call to action may involve the recipient making a phone call, making a purchase, or sending a text message. One or more transaction events are generated as a response to the call to action and are generated on any of transaction system 1 through transaction system N. Non-recipients, defined herein as individuals, e.g., consumers, who did not receive the marketing communication, but who also conduct such transactions as indicated in the call to action(s) of marketing communication. In step 4, an engineer or technically skilled marketing person (shown in FIG. 1 as “engineer”) with access to transaction system 1 through transaction system N extracts transaction logs from all such transaction systems. In step 5, the engineer stores the extracted and possibly cleansed data in a database or file location at a server or at a personal computer, for example. In step 6, the engineer conducts analysis for (e.g., the engineer counts the) the transaction events.

It should be appreciated that from conducting the analysis, correlation of the transaction events to stimulus data (e.g., data reflecting the campaign that have been previously stored in push campaign records) may not be achieved due to any of the following reasons:
Unavailability of a method to determine a response rate;
The manual tool used does not allow for correlation;
Stimulus data is unavailable or inaccessible;
The process taking too long for the data to be of practical use; or
Any combination of the above.

In step 7, the engineer exports results of the conducted analysis. In step 8 (optional), the engineer sends the results of the analysis to the marketing user. It should be appreciated that step 8 is optional because, in an embodiment when the analysis is performed by a technically skilled marketing user, step 8 may not be required.

Further, it should be appreciated that such embodiment as described in FIG. 1 may not filter out “false responses”, defined herein as any of the following:
Transaction events of consumers who were not included in campaign;
Transaction events from consumers on an unrelated transaction system;
Transaction events from consumers on a related transaction system, but for a different product from the one advertised (e.g., in the marketing communication); or
Transaction events for promotions in the far past (e.g., long after the time of promotion or a particular number of hours or days after the time of promotion, and so on.)

As well, it should be appreciated that the embodiment described above may not take place in real time as it relies on manual or only semi automated processing, it may not be scalable for tens or hundreds of concurrent campaigns conducted in a given day, or it may be error prone as it relies on humans.

### Intelligent and Automatic Tracking of Mobile Marketing Campaigns

In an embodiment, a method and apparatus is described in which computing response counts and rates:
may be fully automated;
may be accessible in near real time;
may reflect improved accuracy because such method and apparatus uses contextual information of transaction events to compute response counts and rates; or
may use a flexible filtering algorithm which may be customized via parameterization by an end user.

For example, with such method and apparatus, marketers in the mobile environment are able to send a marketing campaign and monitor the effect of this campaign in real time on a user interface. Such approach opens new possibilities for the marketer, such as, but not limited to, the ability to stop non performing campaigns immediately. It should be appreciated that the uses of such real time or near real time conversion information described above may be many and varied.

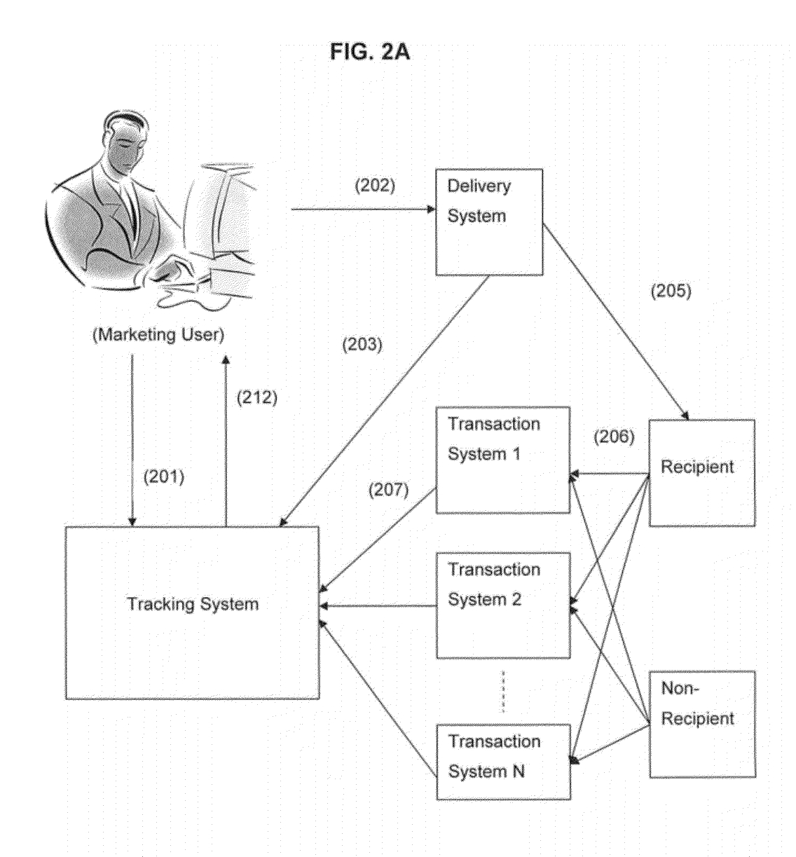

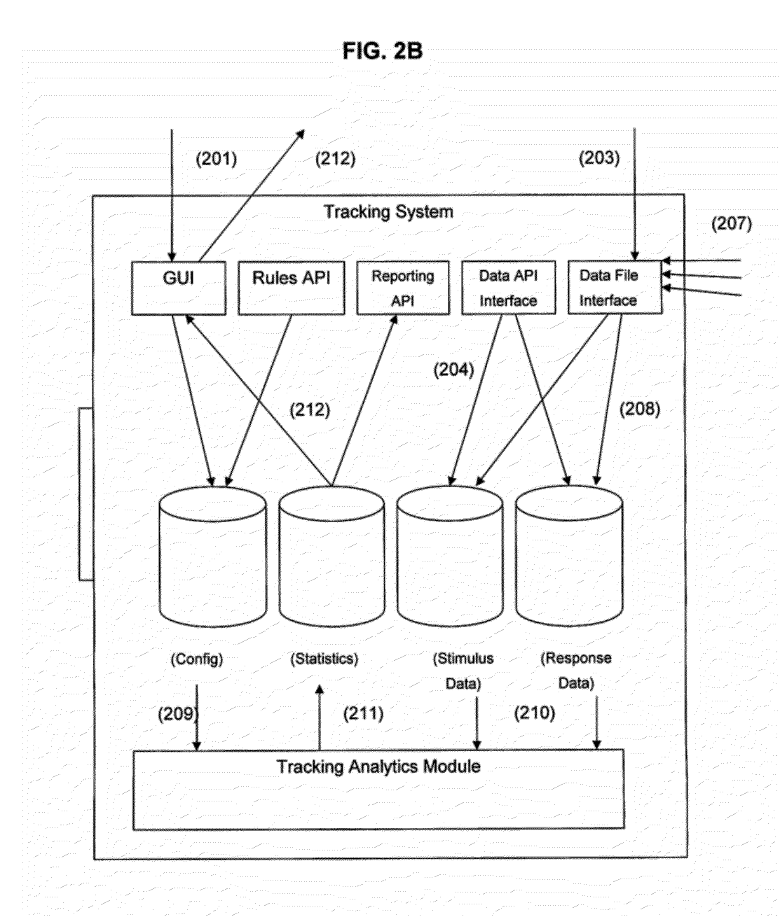

An embodiment for intelligent and automated tracking of mobile marketing campaigns can be described with reference to FIG. 2A-FIG. 2B. In step 201, a marketing user (“marketer”) defines parameters or rules for response tracking prior to initiating a campaign. It should be appreciated that such defined parameters and any other configurations may be template based for repeat campaigns. In an embodiment, some parameters may be, but are not limited to:
Data sources, e.g., transaction systems, from which to accept responses;
Transaction event filters that only accept particular types of transactions (e.g., accepting only the sale of a particular product); or
Time period for which responses are accepted.

In step 202, the marketer initiates a campaign for sending or a schedule configured by the marketer triggers. In step 203, stimulus data, e.g., targeted recipients each with a unique recipient identifier, are submitted to a tracking system, e.g., to a tracking system data file interface (asynchronous) or a data application programming interface (API) (synchronous). In step 204, such stimulus data is stored (e.g., gets persisted) in the tracking system. In step 205, a marketing communication that reflects the campaign is delivered to the recipients by a delivery system. In step 206, some or all recipients (or possibly, no recipients) respond to a call to action of the marketing communication and trigger transaction events in transaction systems, such as any of transaction system 1 through transaction system N. In an embodiment, a call to action may be a monetary transaction, such as a purchase, or may be any other desired event in response to a marketing stimulus (e.g., making a phone call, sending a text message, etc.). It should be appreciated that non-recipients (individuals, such as consumers, who did not receive the marketing communication for any reason) may also trigger a transaction event. In step 207, transaction events are sent to the tracking system. In an embodiment, such transaction events are sent to the data file interface (as an asynchronous transfer) or data API (as a synchronous transfer). In an embodiment, an asynchronous transfer may be pushed by the transaction systems or pulled from the transaction systems by the data file interface. In step 208, either or both of the data interfaces (e.g., file or API) perform data transformations or translations when and according to how data formats require. For example, such data may be cleansed or reformatted. Such transformed or cleansed response data is persisted (or stored) in the tracking system. In step 209, an automated tracking analytics module executes, for example, as asynchronous background process, and may receive updates of any recent or current configuration changes or additions by the marketer. In step 210, the tracking analytics module reads and correlates the stimulus data and response data based on the rules or parameters configured by the marketer. An embodiment of a particular algorithm is described herein below in the section, titled, “AN EXAMPLE IMPLEMENTATION”. In step 211, the tracking analytics module persists or stores the results of such analytics process (e.g., statistics of or correlations of the stimulus data and response data) in a storage, such as in a statistics database schema. In step 212, the marketer may monitor response counts and rates from the graphical user interface that reads the persisted results data or statistics. As well, the marketer may access the same data through any third party system that accesses the Reporting API (not shown).

### An Example Embodiment

It has been found that some push mobile marketing channels, such as Short Message Service (SMS), Wireless Application Protocol (WAP) Push, Multi-Media Messaging Service (MMS), Unstructured Supplementary Services Data (USSD), voice messaging, etc. may not carry session information when recipients respond to a campaign. A session is a conversation context between a computer system and a user (e.g., the consumer). Sessions may aid in understanding or determining the context of a consumer interaction in a multi step conversation. For example, when a response comes from the user, such message is associated with the conversation state. When there is not a session in a series of interactions or conversation, each such interaction by the consumer is considered a new, unsolicited message without any context. For example, when making a purchase in an online shop the user adds goods into a shopping cart. Later the user clicks on check out to pay for the goods. To enable this functionality the associated ecommerce system is required to have established a session, storing the context of the interaction between each page load of the site (e.g., identity and list of goods added to the shopping cart, etc.) to be able to compute the charges. Thus, in a mobile marketing context, any interaction as a response to such a channel may be considered an unsolicited or unrelated transaction event. As well, a marketer may not be able to distinguish between a recipient of the campaign following the call to action and a non-recipient of the campaign performing the same action. Thus, it has been found that some push mobile marketing channels may lead to inaccuracy or random variance of measuring mobile marketing response rate. In an embodiment further described below, a method and apparatus intelligently and automatically considers responses from recipients of a marketing campaign for computing the mobile marketing response rate.

Further, a mobile marketing system may be used to promote different types of products that are purchased or transacted in different systems (e.g., mobile ringtones in a content management system or mobile credit top-up in mobile prepaid recharge systems). With many data streams integrating into a mobile marketing system, the marketer may get false or double responses when recipients of the campaign purchase a different product on a different system that has no relation to the products advertised in the campaign. Thus, it has been found that some push mobile marketing channels may lead to inaccuracy or random variance of measuring mobile marketing response rate. In an embodiment further described below, a method and apparatus intelligently and automatically considers responses from recipients of a marketing campaign from a particular source for computing the mobile marketing response rate.

Further, a mobile marketing system may be used to promote different products of the same type that are purchased or transacted in the same system (e.g., mobile ringtones and mobile phone wallpapers may be purchased in a same content management system). With recording multiple purchases in the transaction system by the same recipients, the marketer may get false responses when recipients of the campaign purchase a different product in the same system that has no relation to the product advertised in the campaign. Thus, it has been found that some push mobile marketing channels may lead to inaccuracy or random variance of measuring mobile marketing response rate. In an embodiment further described below, a method and apparatus intelligently and automatically considers responses from recipients that purchased a same product that was advertised in the marketing campaign.

Further, there may be purchases or transactions for products promoted in mobile marketing campaigns very long after the time of promotion. For example, many responses to a call to action on a mobile campaign occur in hours or days from the time of promotion. Transaction events occurring or being sent or pulled after a particular time passes may have been stimulated through some other promotion. Thus, it has been found that some push mobile marketing channels may lead to inaccuracy or random variance of measuring mobile marketing response rate. In an embodiment further described below, a method and apparatus intelligently and automatically considers responses from recipients that purchased products or services in a desired period after the promotion.

### An Example Implementation

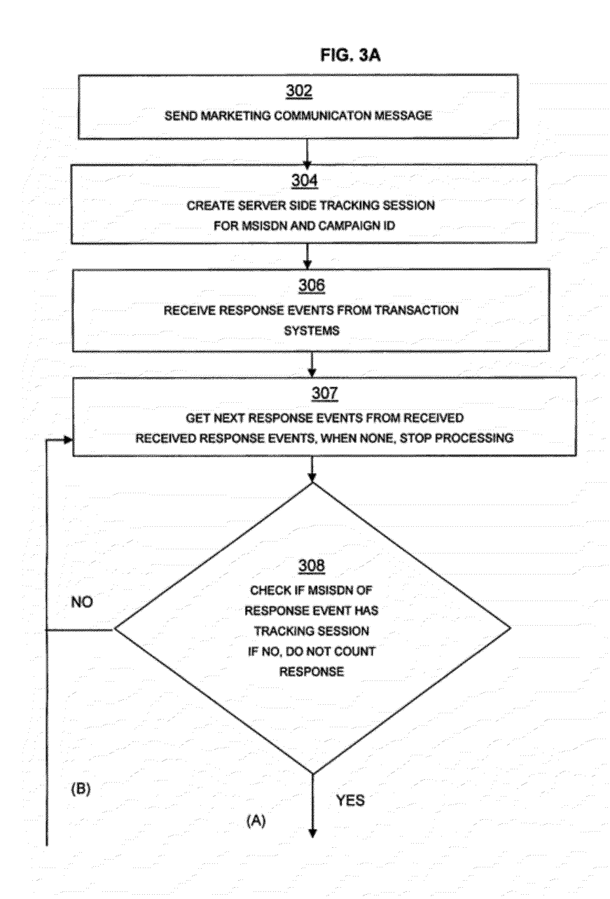

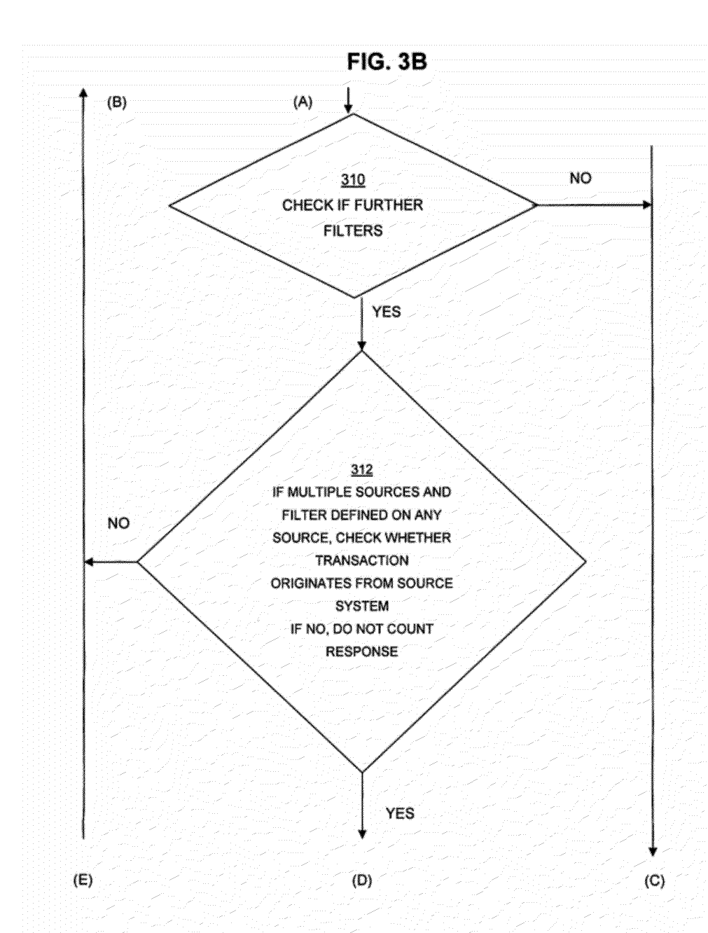

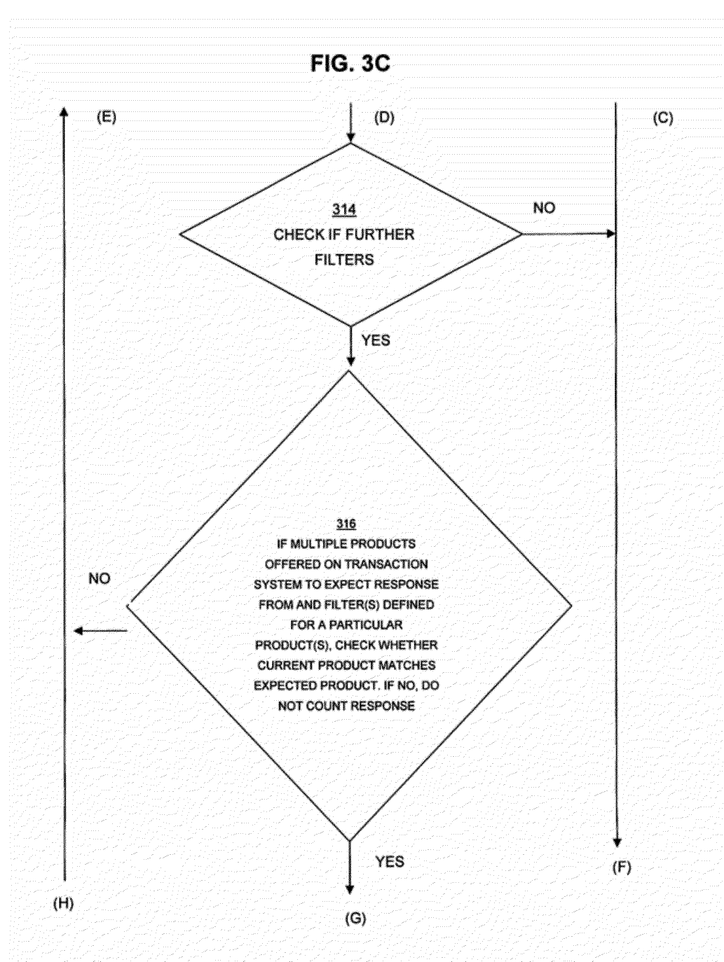

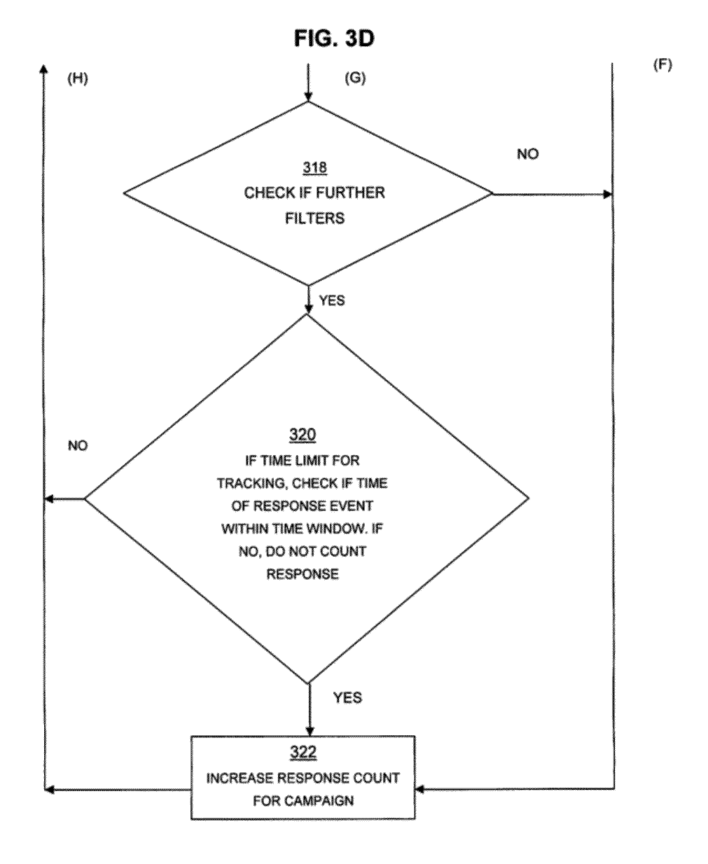

An embodiment of an example implementation can be described with reference to FIG. 3A-FIG. 3D. It should be appreciated that particular details are meant by way of illustration only and are not meant to be limiting. In step 302, a marketer sends a marketing communication message reflecting a campaign intended for target recipients. In step 304, a server side tracking session is created for each individual unique identifier (shown in FIG. 3A by way of example, but not limited to, as a Mobile Subscriber Integrated Services Digital Network (MSISDN) number or mobile number) of the target recipients and campaign identifier. In step 306, a tracking system receives tracking events (“response events”) from transaction systems in real time or semi-real time (e.g., in file batches) and proceeds to process each response event with its own context (such as a MSISDN number of the recipient). In step 307, a processor at the tracking system gets a next response event from the received response events and when no more response events, stops processing. In step 308, for that particular response event, the processor checks if the MSISDN (or mobile number) of the response has a tracking session associated with it. If not, the processor does not increase a given response count for the campaign, stops processing the response event with this unmatched MSISDN and returns to step 307, to continue processing by obtaining the next response event. If yes, in step 310, the processor checks if there are any further filters that had been previously configured by the marketer. If there are no such filters, then control goes to step 322. In step 322, the same or different processor increases the response count for the campaign and returns control to step 307.

If there are such filters, control goes to step 312. In step 312, a processor of the tracking systems checks if there are multiple source systems for response data and checks if there is a filter defined on a particular source system of the multiple source systems, and if so, checks if the current response event originates from this source system. If the previous checks fail, then the response count for the campaign is not increased and control returns to step 307. Otherwise, control goes to step 314 in which a processor of the tracking system checks for any further filters previously configured by the marketer. If there are no such filters, then control goes to step 322. In step 322, the same or different processor increases the response count for the campaign and returns control to step 307.

If there are such filters, control goes to step 316. In step 316, a processor of the tracking systems checks if there are multiple products offered on the transaction systems (or particular source system) that is configured by the marketer in the mobile marketing system as a system to expect responses from, checks if there are filters defined in the mobile marketing system for a particular product or selection of products, and then checks if the current product of the transaction event matches the expected product in the tracking session. If the previous checks fail, then the response count for the campaign is not increased and control returns to step 307. Otherwise, control goes to step 318 in which a processor of the tracking system checks for any further filters previously configured by the marketer. If there are no such filters, then control goes to step 322. In step 322, the same or different processor increases the response count for the campaign and returns control to step 307.

If there are such filters, control goes to step 320. In step 320, a processor of the tracking systems checks if there is a time limit configured for tracking check whether the time of the transaction event (which may not be the current time) is within the configured time window of the respective campaign. It should be appreciated that time windows may be different for each campaign. If no, then the response count for the campaign is not increased and control returns to step 307. Otherwise, control goes to step 322. In step 322, the same or different processor increases the response count for the campaign and returns control to step 307.

It should be appreciated that the specific filters illustrated in FIG. 3A-FIG. 3D are meant by way of example only. In an embodiment, not all illustrated filters are required or other filters not illustrated but within scope of the invention are contemplated. It should be appreciated that the order of the specific filters illustrated in FIG. 3A-FIG. 3D are meant by way of example only. In an embodiment, a different order of such filters is contemplated. In an embodiment, one or more filters may be processed in parallel, such that no filter is required to be a successor of another. As another example, in an embodiment, only the filters as illustrated in step 308 and in step 320 are configured. In such example, the particular processing flow acts only on those two filters. In such example, only if both filters result in a match, then the count is increased.

### Example Hardware Implementations

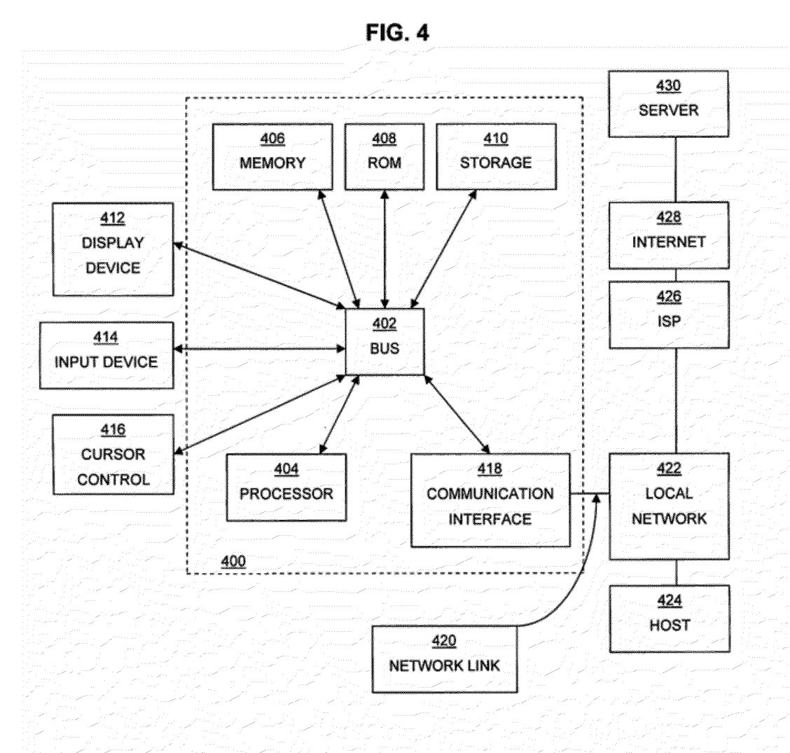

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to storage media and transmission media. Storage media includes both non-volatile media and volatile media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

Accordingly, although the invention has been described in detail with reference to particular preferred embodiments, persons possessing ordinary skill in the art to which this invention pertains will appreciate that various modifications and enhancements may be made without departing from the spirit and scope of the claims that follow.

1. A method, comprising:
storing, by a first storing processor at a server, one or more parameter values associated with a mobile marketing campaign, responsive to input from a user;
receiving, by a first receiving processor at said server, stimulus data reflecting one or more target recipients, responsive to a mobile marketing communication message, reflecting said mobile marketing campaign, being sent to said one or more target recipients;
receiving, by a second receiving processor at said server, one or more transaction events in real-time or in batch file, each transaction event comprising data reflecting contextual information;
determining, by a tracking analytics processor at said server, correlations between said stimulus data and said one or more transaction events based on said one or more parameter values and said data reflecting contextual information, thereby generating correlation results;
computing, by said tracking analytics processor at said server, zero or more response counts for said mobile marketing campaign based on said correlations results; and
storing, by a second storing processor at said server, said one or more response counts for monitoring by said user.

2. The method of claim 1, further comprising:
computing, by said tracking analytics processor, and storing, by a third storing processor at said server, one or more response rates based on said one or more response counts.

3. The method of claim 1, wherein said stimulus data further comprises a first mobile identifier associated with a first target recipient of said one or more target recipients;
wherein said contextual information of a particular transaction event further comprises a second mobile identifier;
wherein determining correlations between said stimulus data and said one or more transaction events is further based on determining whether said second mobile identifier matches said first mobile identifier; and
wherein computing zero or more response counts further comprises:
if said second mobile identifier does not match said first mobile identifier, then not increasing said response counts; and
if said second mobile identifier matches said first mobile identifier, then
(a) determining whether said one or more parameter values comprises a filter;
if no further filter, then increasing response count;
if a filter, then performing filter and
if satisfying filter, then repeating (a) with a new filter, and
if not satisfying filter, then not increasing response count.

4. The method of claim 3, wherein said filter is one or more transaction systems from which to accept transaction events.

5. The method of claim 3, wherein said filter is one or more particular types of transaction events that are acceptable.

6. The method of claim 3, wherein said filter is a time period for which transaction events are acceptable.

7. A tangible computer-readable storage medium storing one or more sequences of instructions which, when executed by one or more processors, causes the one or more processors to perform the following steps, comprising:
storing, by a first storing processor at a server, one or more parameter values associated with a mobile marketing campaign, responsive to input from a user;
receiving, by a first receiving processor at said server, stimulus data reflecting one or more target recipients, responsive to a mobile marketing communication message, reflecting said mobile marketing campaign, being sent to said one or more target recipients;
receiving, by a second receiving processor at said server, one or more transaction events in real-time or in batch file, each transaction event comprising data reflecting contextual information;
determining, by a tracking analytics processor at said server, correlations between said stimulus data and said one or more transaction events based on said one or more parameter values and said data reflecting contextual information, thereby generating correlation results;
computing, by said tracking analytics processor at said server, zero or more response counts for said mobile marketing campaign based on said correlations results; and
storing, by a second storing processor at said server, said one or more response counts for monitoring by said user.

8. The computer-readable storage medium of claim 7, further comprising instructions which when executed cause:
computing, by said tracking analytics processor, and storing, by a third storing processor at said server, one or more response rates based on said one or more response counts.

9. The computer-readable storage medium of claim 7, wherein said stimulus data further comprises a first mobile identifier associated with a first target recipient of said one or more target recipients,
wherein said contextual information of a particular transaction event further comprises a second mobile identifier,
wherein instructions which when executed cause determining correlations between said stimulus data and said one or more transaction events is further based on instructions which when executed cause determining whether said second mobile identifier matches said first mobile identifier; and
wherein instructions which when executed cause computing zero or more response counts further comprises instructions which when executed cause:
if said second mobile identifier does not match said first mobile identifier, then not increasing said response counts; and
if said second mobile identifier matches said first mobile identifier, then
(a) determining whether said one or more parameter values comprises a filter;
if no further filter, then increasing response count;
if a filter, then performing filter and
if satisfying filter, then repeating (a) with a new filter, and
if not satisfying filter, then not increasing response count.

10. The computer-readable storage medium of claim 9, wherein said filter is one or more transaction systems from which to accept transaction events.

11. The computer-readable storage medium of claim 9, wherein said filter is one or more particular types of transaction events that are acceptable.

12. The computer-readable storage medium of claim 9, wherein said filter is a time period for which transaction events are acceptable.

13. An apparatus, comprising:
a first storing processor at a server that stores one or more parameter values associated with a mobile marketing campaign, responsive to input from a user;
a first receiving processor at said server that receives stimulus data reflecting one or more target recipients, responsive to a mobile marketing communication message, reflecting said mobile marketing campaign, being sent to said one or more target recipients;
a second receiving processor at said server that receives one or more transaction events in real-time or in batch file, each transaction event comprising data reflecting contextual information;
a tracking analytics processor at said server that determines correlations between said stimulus data and said one or more transaction events based on said one or more parameter values and said data reflecting contextual information, and that thereby generates correlation results;
wherein said tracking analytics processor computes zero or more response counts for said mobile marketing campaign based on said correlations results; and
a second storing processor at said server that stores said one or more response counts for monitoring by said user.

14. The apparatus of claim 13, wherein said tracking analytics processor computes one or more response rates based on said one or more response counts and further comprising a third storing processor at said server that stores said one or more response rates.

15. The apparatus of claim 13, wherein said stimulus data further comprises a first mobile identifier associated with a first target recipient of said one or more target recipients;
wherein said contextual information of a particular transaction event further comprises a second mobile identifier;
wherein said tracking analytics processor further determines correlations between said stimulus data and said one or more transaction events, based on determining whether said second mobile identifier matches said first mobile identifier; and
wherein said tracking analytics processor that computes zero or more response counts determines:
if said second mobile identifier does not match said first mobile identifier, then does not increase said response counts; and
if said second mobile identifier matches said first mobile identifier, then
(a) determines whether said one or more parameter values comprises a filter;
if no further filter, then increases response count;
if a filter, then performs filter and
if satisfies filter, then repeats (a) with a new filter, and
if does not satisfy filter, then does not increase response count.

16. The apparatus of claim 15, wherein said filter is one or more transaction systems from which to accept transaction events.

17. The apparatus of claim 15, wherein said filter is one or more particular types of transaction events that are acceptable.

18. The apparatus of claim 15, wherein said filter is a time period for which transaction events are acceptable.
